(19) United States
(12) Patent Application Publication
(10) Pub. No.: US 2025/0378117 A1
(43) Pub. Date: Dec. 11, 2025

(54) SYSTEMS AND METHODS FOR A CIRCUIT GENERATION AND HOSTING AND MANAGEMENT APPLICATION

(71) Applicant: CIRCUIT HOLDINGS, INC., Austin, TX (US)

(72) Inventors: George Tyson TUTTLE, Austin, TX (US); Oeivind A. G. LOE, Austin, TX (US); Patrick O'KEEFFE, Austin, TX (US); Higinio O. MAYCOTTE, Austin, TX (US)

(21) Appl. No.: 18/737,085

(22) Filed: Jun. 7, 2024

(51) Int. Cl. G06F 16/93; G06N 5/022

(52) U.S. Cl. CPC G06F 16/93; G06N 5/022

(57) ABSTRACT

Disclosed are systems and methods for a decision intelligence (DI)-based computerized framework that provides customized circuits that enable interactions for users with curated, network-hosted electronic resources, as they relate to a user(s). The disclosed framework provides mechanisms for determining and leveraging a deep user-based context to automatically surface information and/or recommend actions that are temporally, spatially, socially and/or logically relevant to a user. The framework operates to build, curate and manage a circuit on/over a network at a network location via the retrieval and AI/ML and/or LLM-based analysis of data, which can enable enhanced consumption, and improved interactions on/over the network, with other network resources and/or other users.

### FIELD OF THE DISCLOSURE

The present disclosure is generally related to an electronic information and resource management and dissemination system, and more particularly, to a decision intelligence (DI)-based computerized framework for deterministically managing, controlling, creating, sharing and hosting electronic resource information by and between entities.

### SUMMARY OF THE DISCLOSURE

The disclosed systems and methods provide a novel computerized framework that operates to curate customized electronic resource experiences for users, which can include, but are not limited to, people (e.g., a person or group of people), entities, companies, government, agencies, cities, regions, and the like. For example, as discussed herein, the disclosed framework functions via computerized mechanisms to retrieve, extract, determine or otherwise identify information of interest and/or relation to a user, for example, and compile such information into a dynamic data structure for consumption by such user and/or other users, which may be availed access to the data structure via permissioned access, granted access to a request and/or subscription-based access rights, among others, as discussed herein.

According to some embodiments, the disclosed data structure, which can be an electronic content file and/or executable file, can be realized for display and/or consumption as, but not limited to, an application, web page, portal, browser, electronic message, interface, and/or other form of known or to be known electronic and/or digital file, object or item for which content can be collected, curated and consumed by permitted users (and/or other platforms). For example, the disclosed data structure, referred to as a “circuit,” can be compiled as an electronic file displayed on a specific web page within a browser (and/or a browser user interface (UI), for example), whereby collected information related to a topic(s) for a user can be organized and presented for consumption to the user. Examples of such curation and operation are discussed below in more detail.

By way of background, on a daily average, an estimated five quintillion bytes of data are generated daily on the Internet; however, almost 97% of such data remains untapped. Currently, there are no mechanisms available that provide a unified solution for users to manage such deluge of information. For example, users are constantly inundated with copious volumes of emails, texts, application notifications, news updates, and the like. Currently, users are limited to the option of manually sifting through such notifications and alerts via each individualized application (e.g., email app, SMS app, news app(s), and the like); however, such disjointed approach not only fails to enable the user to keep up with the constant stream of information, but also fails to provide a user with a context in to which how such notifications/alerts can/may relate to one another and/or the user, in general.

For example, if a user receives a news alert about a fire, a text from their spouse and an email from the municipality, the user would have to individually check each message (via each separate application) and then manually discern and coordinate the information related therein. With the advent of the disclosed framework, as discussed herein, the disclosed systems and methods address such shortcomings, among others, by operating to collate such data into a circuit for a user (e.g., or update an already established circuit for the user), and provide a unified network location/resource for the user to consume the timely information.

Some conventional systems attempt to address such technical problems; however, they fall short in efficiency, accuracy and robustness in being able to properly curate all the information that may be of relevance to a user. For example, current artificial intelligence (AI) search engines can scan and index data, and personalize results for the user. However, these are tied to siloed data storage, and do not contemplate nor provide functionality for identifying, searching and indexing information from and across disparate network locations remotely located on the Internet and on local data stores associated with users, whereby robust, customized circuits can then be compiled, as discussed herein.

Thus, as discussed herein, the disclosed systems and methods operational framework provides novel mechanisms for determining and leveraging a deep user-based context to automatically surface information and/or recommend actions that are temporally, spatially, socially, emotionally and/or logically relevant to a user. As discussed in more detail below, the disclosed framework operates to build, curate and manage a circuit, which can involve information related to, but not limited to, a user(s), the user's interests, behaviors, geographical information, demographics, real-world activities, digital activities, topics, categories, preferences, other circuits, and the like, or some combination thereof. Accordingly, in some embodiments, the disclosed circuit framework can function to provide capabilities that enable the retrieval of data not previously available to users, which can enable enhanced information consumption, and improved interactions on/over the network, with other network resources and/or other users, and the like.

For purposes of this disclosure, it should be understood that while reference is made to users, it should not be construed as limited to people, as one of skill in the art would readily understand that a user can be, but is not limited to, a person, group, entity, virtual client, company, organization, government, agency, municipality, demographic, region, geographic area, and/or any other type of identifiable subject for which content can be customized for and provided to, as discussed herein, without departing from the scope of the instant disclosure.

According to some embodiments, the disclosed framework can generate, manage, share and host circuits via novel mechanisms that understand the current and/or future needs of users. Such novel mechanisms, as discussed in more detail below, can involve the integration and/or implementation of artificial intelligence (AI), machine learning (ML) and/or large language models (LLMs). As discussed in more detail below, collected data related to electronic resources, for example, can be analyzed via such known or to be known AI/ML models and/or LLMs, such that curated circuit information and/or actions events, as well as currently detected data related to current and/or ongoing circuit versions can determined therefrom. Accordingly, the disclosed framework can provide a dynamically adaptive, automated circuit building and hosting resource (e.g., application, web site, platform, for example) that can leverage generative software to control how and what types of data are provided to users and/or made available to users via their currently determined and/or predicted contexts, inter alia.

The latest transformer-based LLMs have, among other features and capabilities, theory of mind, abilities to reason, abilities to make a list of tasks, abilities to plan and react to changes (via reviewing their own previous decisions), abilities to understand multiple data sources (and types of data-multimodal), abilities to have conversations with humans in natural language, abilities to adjust, abilities to interact with and/or control application program interfaces (APIs), abilities to remember information long term, abilities to use tools (e.g., read multiple schedules/calendars, command other systems, search for data, and the like), abilities to use other LLM and other types of AI/ML (e.g., neural networks to look for patterns, recognize humans, pets, and the like, for example), abilities to check whether reports, ability to talk to other devices over standard device-to-device protocols, abilities to improve itself, abilities to correct mistakes and learn using reflection, and the like.

Thus, as provided herein, the disclosed integration of such AI/ML and/or LLM technology provides an improved framework for content generation and consumption over the Internet for all types and variations of users. As evidenced from the instant disclosure, this can lead to an improved content environment for a user (e.g., improved user experience), as well as an improved operational efficiency, resource management and management of network hosted data (e.g., improved key performance indicators (KPIs), for example).

According to some embodiments, a method is disclosed for a DI-based computerized framework for deterministically managing, controlling, creating, sharing and hosting electronic resource information by and between users. In accordance with some embodiments, the present disclosure provides a non-transitory computer-readable storage medium for carrying out the above-mentioned technical steps of the framework's functionality. The non-transitory computer-readable storage medium has tangibly stored thereon, or tangibly encoded thereon, computer readable instructions that when executed by a device cause at least one processor to perform a method for a DI-based computerized framework for deterministically managing, controlling, creating, sharing and hosting electronic resource information by and between users.

In accordance with one or more embodiments, a system is provided that includes one or more processors and/or computing devices configured to provide functionality in accordance with such embodiments. In accordance with one or more embodiments, functionality is embodied in steps of a method performed by at least one computing device. In accordance with one or more embodiments, program code (or program logic) executed by a processor(s) of a computing device to implement functionality in accordance with one or more such embodiments is embodied in, by and/or on a non-transitory computer-readable medium.

### DESCRIPTIONS OF THE DRAWINGS

The features, and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure:

FIG. 1A is a block diagram of an example configuration within which the systems and methods disclosed herein could be implemented according to some embodiments of the present disclosure;

FIG. 1B is a block diagram illustrating components of an exemplary system according to some embodiments of the present disclosure;

FIG. 2 depicts a non-limiting example embodiment according to some embodiments of the present disclosure;

FIG. 3 depicts a non-limiting example embodiment according to some embodiments of the present disclosure;

FIG. 4 illustrates an exemplary work flow according to some embodiments of the present disclosure;

FIG. 5 illustrates an exemplary work flow according to some embodiments of the present disclosure;

FIG. 6 illustrates an exemplary work flow according to some embodiments of the present disclosure;

FIG. 7 depicts an exemplary implementation of an architecture according to some embodiments of the present disclosure;

FIG. 8 depicts an exemplary implementation of an architecture according to some embodiments of the present disclosure; and

FIG. 9 is a block diagram illustrating a computing device showing an example of a client or server device used in various embodiments of the present disclosure.

### DETAILED DESCRIPTION

The present disclosure will now be described more fully hereinafter with reference to the accompanying drawings, which form a part hereof, and which show, by way of non-limiting illustration, certain example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described below with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

For the purposes of this disclosure a non-transitory computer readable medium (or computer-readable storage medium/media) stores computer data, which data can include computer program code (or computer-executable instructions) that is executable by a computer, in machine readable form. By way of example, and not limitation, a computer readable medium may include computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, optical storage, cloud storage, magnetic storage devices, or any other physical or material medium which can be used to tangibly store the desired information or data or instructions and which can be accessed by a computer or processor.

For the purposes of this disclosure the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Cloud servers are examples.

For the purposes of this disclosure a “network” should be understood to refer to a network that may couple devices so that communications may be exchanged, such as between a server and a client device or other types of devices, including between wireless devices coupled via a wireless network, for example. A network may also include mass storage, such as network attached storage (NAS), a storage area network (SAN), a content delivery network (CDN) or other forms of computer or machine-readable media, for example. A network may include the Internet, one or more local area networks (LANs), one or more wide area networks (WANs), wire-line type connections, wireless type connections, cellular or any combination thereof. Likewise, sub-networks, which may employ differing architectures or may be compliant or compatible with differing protocols, may interoperate within a larger network.

For purposes of this disclosure, a “wireless network” should be understood to couple client devices with a network. A wireless network may employ stand-alone ad-hoc networks, mesh networks, Wireless LAN (WLAN) networks, cellular networks, or the like. A wireless network may further employ a plurality of network access technologies, including Wi-Fi, Long Term Evolution (LTE), WLAN, Wireless Router mesh, or 2nd, 3rd, 4^{th} or 5^{th} generation (2G, 3G, 4G or 5G) cellular technology, mobile edge computing (MEC), Bluetooth, 802.11b/g/n, or the like. Network access technologies may enable wide area coverage for devices, such as client devices with varying degrees of mobility, for example.

In short, a wireless network may include virtually any type of wireless communication mechanism by which signals may be communicated between devices, such as a client device or a computing device, between or within a network, or the like.

A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

For purposes of this disclosure, a client (or user, entity, subscriber or customer) device may include a computing device capable of sending or receiving signals, such as via a wired or a wireless network. A client device may, for example, include a desktop computer or a portable device, such as a cellular telephone, a smart phone, a display pager, a radio frequency (RF) device, an infrared (IR) device, virtual client, a Near Field Communication (NFC) device, a Personal Digital Assistant (PDA), a handheld computer, a tablet computer, a phablet, a laptop computer, a set top box, a wearable computer, smart watch, an integrated or distributed device combining various features, such as features of the forgoing devices, or the like.

A client device may vary in terms of capabilities or features. Claimed subject matter is intended to cover a wide range of potential variations, such as a web-enabled client device or previously mentioned devices may include a high-resolution screen (HD or 4K for example), one or more physical or virtual keyboards, mass storage, one or more accelerometers, one or more gyroscopes, global positioning system (GPS) or other location-identifying type capability, or a display with a high degree of functionality, such as a touch-sensitive color 2D or 3D display, for example.

Certain embodiments and principles will be discussed in more detail with reference to the figures. According to some embodiments, the disclosed systems and methods provide advanced computerized mechanisms to create and host circuits, which as discussed above and in more detail below, are collections of electronic/digital information (e.g., documents, as discussed below) accessed and retrieved across a network that are analyzed and curated (e.g., modified and/or organized) according to a context(s) that relates to a user, event and/or other pivot point for which a collection of related data can be of use to a user—for example, after a hurricane in a region, a circuit can be created that provides all the emergency information local users would need, which can be shared with each user via the disclosed platform. As discussed in more detail below, a circuit can function as a resource location for the collaboration between users to author, modify, share and/or host content for consumption by and/or between such users.

Accordingly, as discussed herein, in some embodiments, circuits can be public, secured, privately subscribed to, shared (e.g., publicly, per request, and/or per subscription), and the like, and can include interactive functionality that provides capabilities for the information included therein to be interacted with, acted upon and the like, as well as capabilities for interactions with other users and/or circuits.

By way of a non-limiting example, an employer may want their employees to be more connected to internal data and external data (e.g., data on the Internet, and hosted by a specific third party entity). Thus, in some embodiments, as discussed herein, the employer can create (e.g., author) a company circuit(s) for the employees and non-employees, which can include the internal information and external information. In another non-limiting example, a company can create one or more private circuits that can be accessed by different levels of employees, and one or more public circuits that can also be accessed by non-employees. Thus, employees can be given secure access to internal company information, and the general public can receive public access to public company information.

By way of another non-limiting example, a company may have raw data in multiple places, and wants to automate the organization of such data. As discussed herein, circuit workflows can be executed that cause the collection, analysis and curation of such data into a circuit or set of circuits. Therefore, for example, appropriate users/employees can be subscribed to the appropriate circuit (e.g., managers can access employee circuits; human resources (HR) can access all an employee circuit(s) (e.g., a circuit for all employees, with circuits per employee, for example); accounting can access accounts receivable (AR) circuits; and the like.

In another non-limiting example, users can create circuits on topics that interest them, whereby content/information related to their interests can be retrieved from network locations, which include other users' circuits. In some embodiments, as discussed below, this can involve creating a new circuit for the users, creating new versions of established circuits, annotating existing circuits, and the like.

In some embodiments, users can apply a set of executable instructions related to a revenue model to their circuits, whereby access can be driven by types of subscriptions used to access data (e.g., different rates for more content; different rates/subscription types for abilities to take action (e.g., annotate) content within another user's circuit; and the like, for example).

And, in yet another non-limiting example, governments and organizations can leverage proprietary circuits to promulgate important activities and notifications that are happening, and make sure the appropriate people (e.g., based on their locations and interests, for example) receive them. For example, a new speed limit is instituted on a part of a road within town, the municipality can leverage their circuit to send notifications to users with addresses within town limits.

Accordingly, as discussed in more detail herein, circuits can provide value adds to information by focusing, enhancing, grouping, modifying and/or contextualizing information so that it can be efficiently digested and viewed by the appropriate users, in a contextually timely manner.

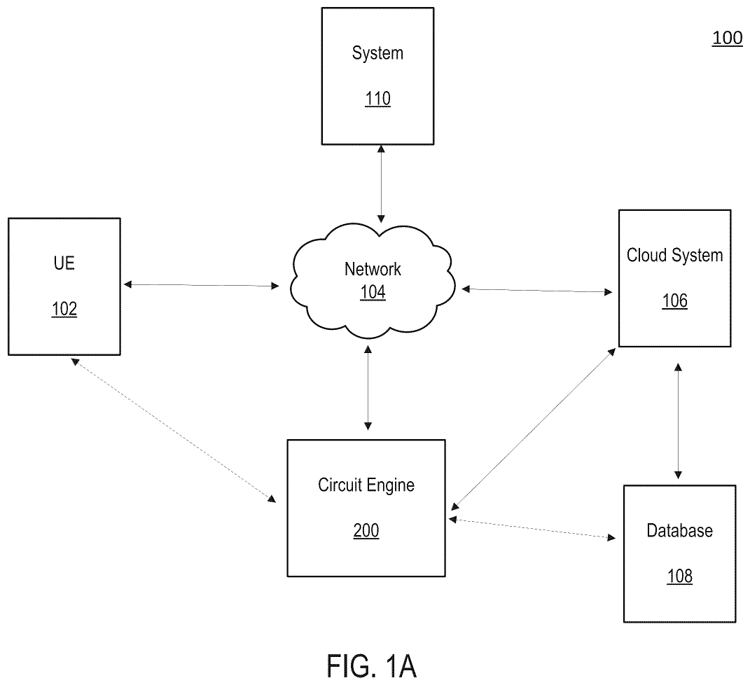

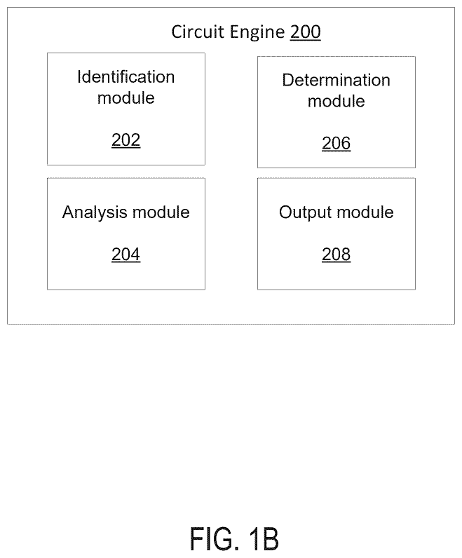

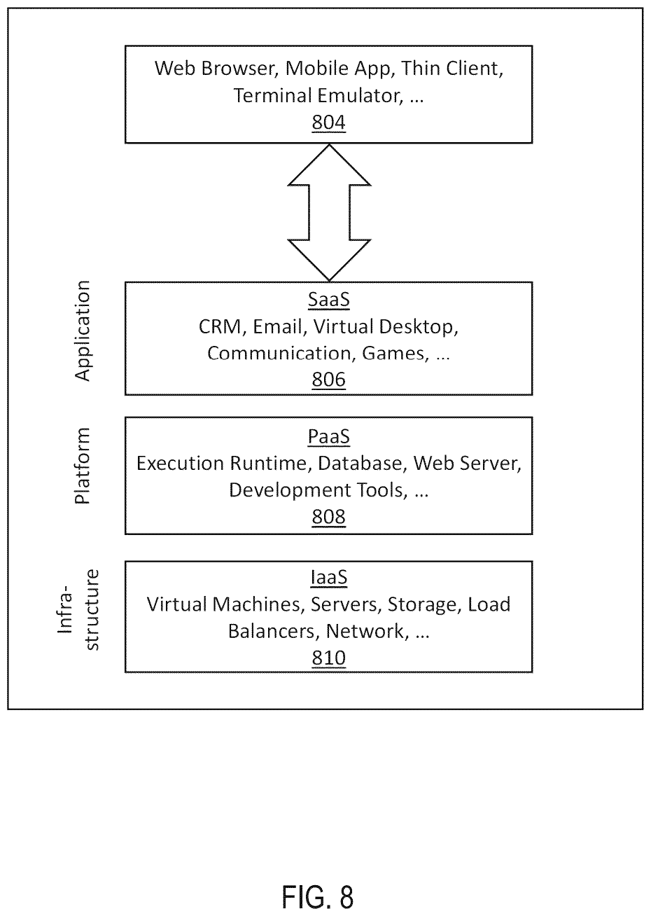

With reference to FIG. 1A, system 100 is depicted which includes user equipment (UE) 102 (e.g., a client device, as mentioned above and discussed below in relation to FIG. 8), system 110, network 104, cloud system 106, database 108 and circuit engine 200.

It should be understood that while system 100 is depicted as including such components, it should not be construed as limiting, as one of ordinary skill in the art would readily understand that varying numbers of UEs, devices, users/entities, systems, cloud systems, engines, databases and networks can be utilized; however, for purposes of explanation, system 100 is discussed in relation to the example depiction in FIG. 1A.

According to some embodiments, UE 102 can be any type of device, such as, but not limited to, a mobile phone, tablet, laptop, sensor, Internet of Things (IoT) device, wearable device, autonomous machine, smart television, media streaming device, game console, and any other device equipped with a cellular or wireless or wired transceiver.

In some embodiments, peripheral devices (not shown) can be connected to UE 102, and can be any type of peripheral device, such as, but not limited to, a wearable device (e.g., smart ring, smart watch, for example), printer, speaker, sensor, and the like. In some embodiments, a peripheral device can be any type of device that is connectable to UE 102 via any type of known or to be known pairing mechanism, including, but not limited to, WiFi, Bluetooth™, Bluetooth Low Energy (BLE), NFC, and the like.

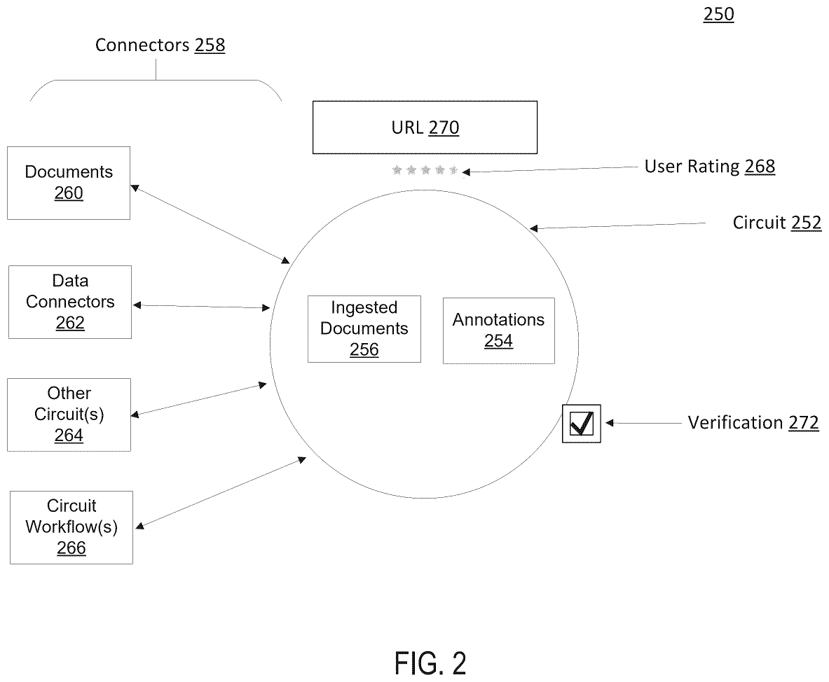

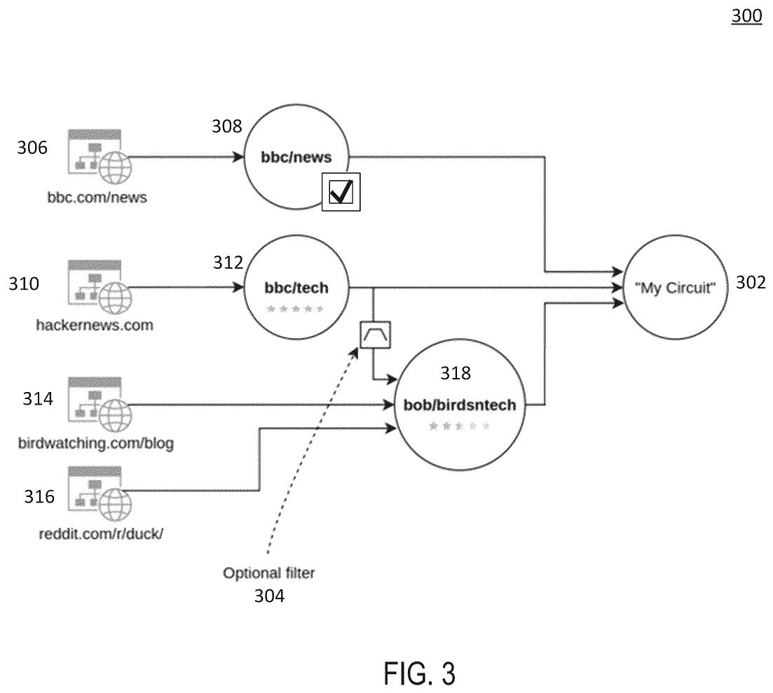

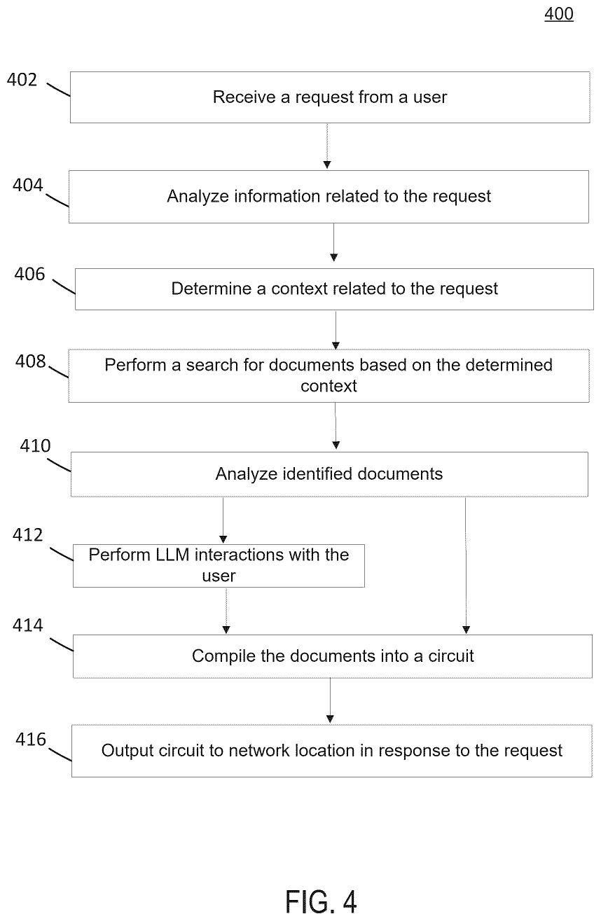

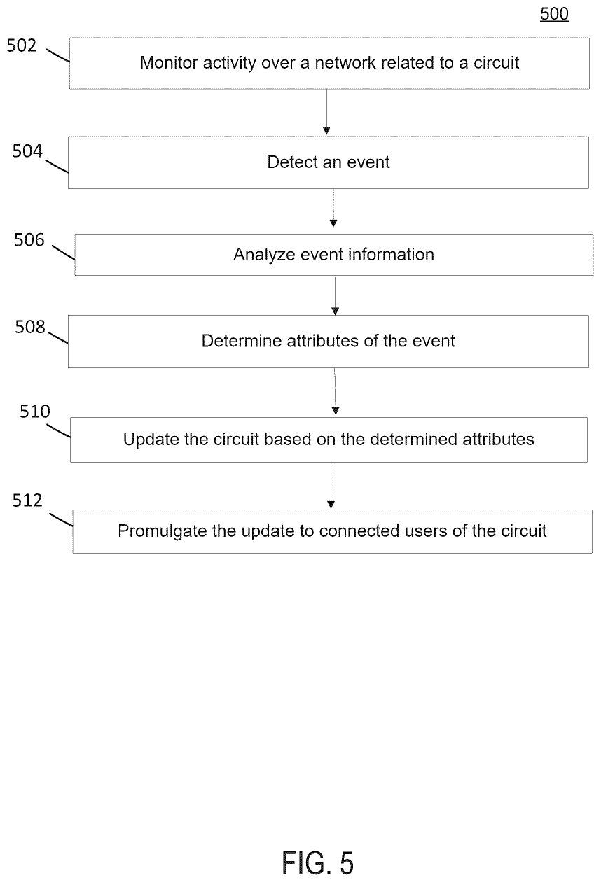

According to some embodiments, system 110 can correspond to any type of device (or UE, as discussed above), computer system, electronic platform, web portal, web site, electronically hosted network resource, and the like, or some combination thereof. In some embodiments, for example, system 100 can correspond to a third party web site (e.g., a news web site and/or application, for example) for which a user of UE 102 is electronically interacting with (e.g., at least a threshold amount of times and/or within a threshold period of time from a current time, for example). Examples of how such system 110 imparts functionality within system 100 are provided below in non-limiting example embodiments 250 and 300, depicted in FIGS. 2 and 3, respectively, and within Processes 400 and 500 in FIGS. 4 and 5, respectively.

In some embodiments, network 104 can be any type of network, such as, but not limited to, a wireless network, cellular network, the Internet, and the like (as discussed above). Network 104 facilitates connectivity of the components of system 100, as illustrated in FIG. 1A.

According to some embodiments, cloud system 106 may be any type of cloud operating platform and/or network based system upon which applications, operations, and/or other forms of network resources may be located. For example, system 106 may be a service provider and/or network provider from where services and/or applications may be accessed, sourced or executed from. For example, system 106 can represent the cloud-based architecture associated with a proprietary system provider, which has associated network resources hosted on the internet or private network (e.g., network 104), which enables (via engine 200) the information and/or electronic resource management and monitoring, as discussed herein.

In some embodiments, cloud system 106 may include a server(s) and/or a database of information which is accessible over network 104. In some embodiments, a database 108 of cloud system 106 may store a dataset of data and metadata associated with local and/or network information related to a user(s) of UE 102/system 110 and the UE 102/system 110, and the services and applications provided by cloud system 106 and/or circuit engine 200.

In some embodiments, for example, cloud system 106 can provide a private/proprietary management platform, whereby engine 200, discussed infra, corresponds to the novel functionality system 106 enables, hosts and provides to a network 104 and other devices/platforms operating thereon.

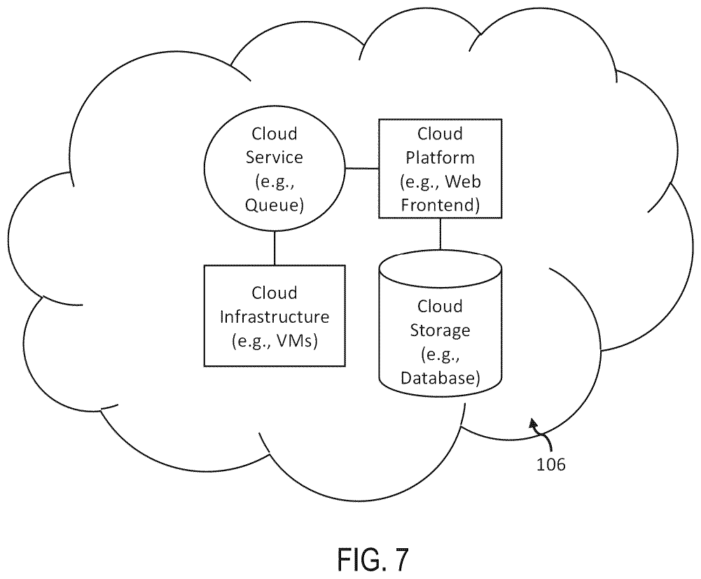

Turning to FIG. 7 and FIG. 8, in some embodiments, the exemplary computer-based systems/platforms, the exemplary computer-based devices, and/or the exemplary computer-based components of the present disclosure may be specifically configured to operate in a cloud computing/architecture 106 such as, but not limiting to: infrastructure a service (IaaS) 810, platform as a service (PaaS) 808, and/or software as a service (SaaS) 806 using a web browser, mobile app, thin client, terminal emulator or other endpoint 804. FIG. 7 and FIG. 8 illustrate schematics of non-limiting implementations of the cloud computing/architecture(s) in which the exemplary computer-based systems for administrative customizations and control of network-hosted application program interfaces (APIs) of the present disclosure may be specifically configured to operate.

Turning back to FIG. 1A, according to some embodiments, database 108 may correspond to a data storage for a platform (e.g., a network hosted platform, such as cloud system 106, as discussed supra) or a plurality of platforms. Database 108 may receive storage instructions/requests from, for example, engine 200 (and associated microservices), which may be in any type of known or to be known format, such as, for example, standard query language (SQL). According to some embodiments, database 108 may correspond to any type of known or to be known storage, for example, a memory or memory stack of a device, a distributed ledger of a distributed network (e.g., blockchain, for example), a look-up table (LUT), and/or any other type of secure data repository

Circuit engine 200, as discussed above and further below in more detail, can include components for the disclosed functionality. According to some embodiments, circuit engine 200 may be a special purpose machine or processor, and can be hosted by a device on network 104, within cloud system 106 and/or on UE 102. In some embodiments, engine 200 may be hosted by a server and/or set of servers associated with cloud system 106.

According to some embodiments, as discussed in more detail below, circuit engine 200 may be configured to implement and/or control a plurality of services and/or microservices, where each of the plurality of services/microservices are configured to execute a plurality of workflows associated with performing the disclosed functionality. Non-limiting embodiments of such workflows are provided below.

According to some embodiments, as discussed above, circuit engine 200 may function as an application provided by cloud system 106. In some embodiments, engine 200 may function as an application installed on a server(s), network location and/or other type of network resource associated with cloud system 106. In some embodiments, engine 200 may function as an application installed and/or executing on UE 102. In some embodiments, such application may be a web-based application accessed by UE 102 and/or devices over network 104 from cloud system 106. In some embodiments, engine 200 may be configured and/or installed as an augmenting script, program or application (e.g., a plug-in or extension) to another application or program provided by cloud system 106 and/or executing on UE 102.

As illustrated in FIG. 1B, according to some embodiments, circuit engine 200 includes identification module 202, analysis module 204; determination module 206 and output module 208. It should be understood that the engine(s) and modules discussed herein are non-exhaustive, as additional or fewer engines and/or modules (or sub-modules) may be applicable to the embodiments of the systems and methods discussed. More detail of the operations, configurations and functionalities of engine 200 and each of its modules, and their role within embodiments of the present disclosure will be discussed below.

Turning to FIG. 2, depicted is non-limiting example 250, which depicts an example embodiment for how electronic information can be mined for curation of a circuit for a user. As discussed herein, example 250 depicts the components that can be used to form a circuit 252. Example 252 includes circuit 252, annotations 254, ingested documents references 256 (referred to as ingested documents, interchangeably), connectors 258, individual documents 260 (or documents, used interchangeably), data connector(s) 262, other circuit(s) 264, circuit workflow(s) 266, user rating 268, uniform resource locator (URL) 270 and owner verified item (verification) 272.

In some embodiments, the annotations 254 can correspond to “circuit-specific annotations,” which can involve, but not be limited to, a combination of document metadata such as ownership information, creation time, permissions, and the like, as well as, but not limited to, information added by a user to extend, correct, clarify and/or add value to the document, and information provided through various automated processing steps, as discussed below at least with reference to FIGS. 4-6 (e.g., Steps 410-414, 510 and 602-610, respectively).

It should be noted that example 250 is a non-limiting example, and not all components are required for the compilation of a circuit 252—for example, other circuits 264 may not be required or requested for generation of a circuit 252.

By way of a non-limiting example, the compilation of circuit 252 can involve the retrieval of information from documents 260, data connectors 262, other circuits 264 and/or circuit workflows 266. As provided below in more detail, such data can be analyzed and compiled into ingested documents 256, which can be hosted and provided via circuit 252. In some embodiments, such documents 256 can be subject to modifications—for example, a user author (and/or, e.g., other subscribed users) of the circuit 252 can provide circuit-specific annotations that enable customization of the ingested documents 256 (e.g., inline edits to document version available within circuit 252).

In some embodiments, as discussed herein, the circuit can be hosted on a web page, which can be accessible via the direct access URL 270. Such URL 270 location may be accessible via a search engine search and/or direct access provided by a message that includes such URL 270. In some embodiments, the URL 270 for circuit 252 can be categorized, which can be indicated in the URL address. For example, categories can include, but are not limited to, company, organization, news, unverified, user, country, and the like. For example, a URL for Company C may be: circuit.ai/C/CompanyX/ . . . , whereby “C” denotes the category of a “company” and “Company X” is the unique company name. In some embodiments, categorization may be tied to whether a user (e.g., Company X) is verified, as discussed below. For example, unverified users may not have a unique category designation in their URL address.

In some embodiments, feedback can be provided to the circuit 252 by other users, whereby such functionality is represented by user rating 268. For example, users who “follow” or subscribe to a circuit 252 can provide feedback via any type of rating, inclusive of comments (not shown).

In some embodiments, the user author (e.g., owner) of the circuit 252 can be “verified”—item 272. In some embodiments, for example, for a circuit 252 and/or user author (owner) to be verified a verification request may be submitted, which can involve providing proof of identity, such as a government-issued identification (ID) (and/or evidence of notability or public interest, for example—which can include links to notable news articles, a significant number of followers, or a threshold satisfying online presence (e.g., a threshold amount of followers on social media, for example)). Accordingly, the disclosed framework can deploy varying forms of criteria and application procedures to perform the verification, which can aid in establishing the authenticity of the user's account, and/or notoriety of the circuit (e.g., marking it with a blue checkmark or badge, for example, as depicted in item 272).

As discussed above, according to some embodiments, circuit 252 is a collection of ingested documents 256. Such ingested documents 256 can be collected, retrieved, extracted and/or otherwise identified from network sources (referred to as “target sources”) via inbound connectors 258, whereby such sources can include, for example, documents 256, data connectors 262, other circuits 264, circuit workflows 266, and the like, or some combination thereof.

For example, circuit 256 can include information from other circuits 264, whereby such other circuits 264 information can be linked to circuit 252. In some embodiments, circuit 252 may not duplicate the information in the other circuits 264 (e.g., which can reduce storage/memory usage, as already hosted data can be pointed to via the other circuits' URL, for example). In some embodiments, the information/documents from the other circuits 266 may be stored as created versions of such information/documents.

According to some embodiments, as discussed herein, documents 260 (e.g., electronic documents from electronic, network sources) are collections of information. For example, a document can be, but is not limited to, a word document, web page, chat thread, image, video, multimedia file, object, item, article, Real Simply Syndication (RSS) feed, and/or any other type of data and/or metadata can be rendered and/or viewed by a user, device and/or application. For example, documents 260 can be an article from the New York Times®, a chat transcript from a user's Facebook® page, an image post or story from the user's Instagram® page, and the like.

In some embodiments, such documents 260, as well as other information from components 262, 264 and/or 266), once input as ingested documents 256, can be subject to annotations 254. As provided herein, annotations 254 can be inline (e.g., within the documents) and/or as whole-document annotations (e.g., edits the document name and other metadata, and/or provide descriptive information about the document, for example). In some embodiments, annotations 254 can be automatically accepted, proposed and/or rejected, and in some embodiments, annotations 254 can be subject to their own annotations (or comments).

In some embodiments, annotations 254 can be layered within a circuit. For example, if a circuit A (e.g., circuit 252) is linked to circuit B (e.g., other circuit 264), and a document 256 in circuit B is annotated within circuit B, an author of circuit A can add additional annotations 254. In some embodiments, such annotations 254 of the document in circuit B may not be viewable by subscribers of circuit A.

In some embodiments, annotations 254 can result in a new document being created within a circuit 252 and/or within other circuits that link to circuit 252 (as discussed in FIG. 3, infra). In some embodiments, at least a portion of the metadata for an annotated document may be recompiled based on the combined document with annotations by the document ingestion, as discussed below (at least in Step 414, infra).

In another example, if a user has two local circuits, where each circuit is subject to added annotations 254 to the same document within each circuit (circuit 1 has the document, and circuit 2 references the document in circuit 1), such annotations can cause two separate “document+layer” instances—that is, there is one instance each circuit, such that if/when such two circuits are referenced by a third circuit, the same document (from each circuit) can show up as two separate documents, both linking back to the original document (in circuit 1). In some embodiments, such two separate documents can bemerged into a third document, thereby combining the annotations of both, through the application of user input, LLMs and/or other AI/ML algorithms.

In some embodiments, data connectors 262 correspond to customization of connectors 258, which enable owners of a circuit 252 to specifically request and/or customize specific types, forms, quantities of information. For example, Company X, dealing with the import/export business, may request data from wholesalers of item Y. This can be realized via data connector 262, which can be determined automatically based on a context of Company X and/or circuit 252, as discussed herein.

In some embodiments, circuit workflows 266 can correspond to a set of instructions defined by an automator to ingest documents along with metadata and any other associated information from one or more sources, perform custom processing steps on this document to modify, extract, transform, split or otherwise enhance the document, then output the resulting document(s) to one or more destinations. Discussion of the functionality of such a circuit workflow is provided below. Sources can include system 110, UE 102, database 108 or another location. A typical destination for the resulting document is a circuit, but can also be system 110, UE 102, database 108 or another location.

By way of a non-limiting example, a circuit workflow 266 can allow a company to read documents from an internal proprietary data system, perform specific enhancements to this data, such as correcting missing information, and output this data to an internal company circuit for employees to leverage.

According to some embodiments, connectors 258 operate as executable workflows (e.g., executable instructions that cause engine 200 to establish such specific pathways, discussed infra) that enable the over-network retrieval and ingestion of documents (260-266) from target sources into circuit (as ingested documents 256). As discussed herein, connectors 258 can be inbound and/or outbound (e.g., cause data to be ingested to a circuit source, and/or provide data to a target source from a circuit, and the like). In some embodiments, a connector 258 can cause the performance of and/or enable operations to extract relevant data from a target data source—for example, a PDF connector can extract text, tables and images, and add relevant context and usage information (which can be derived from pathways 266, discussed supra). Such data can be subject to ingestion processing via engine 200, discussed infra in relation to the steps of Process 400). Further discussion of connectors 258 is provided below in relation to Process 400.

Turning to FIG. 3, depicted is example 300, which provides an example of a circuit 302 that can be generated from target sources (306, 310, 314 316) and corresponding circuits (308, 312 318, respectively). Such circuits 308, 312 and 318 provide another example of the other circuits 264 from FIG. 2, discussed supra.

According to some embodiments, for a given circuit, users interacting with a circuit can have different roles. A role higher in the hierarchy can provide read/write access rights and/or functionality to perform more operations, and/or have increased access to circuit documents than a role lower in the hierarchy. Accordingly, in some embodiments, how a user is slotted/assigned/subscribed within the hierarchy can provide them with modified versions of read/write privileges as they relate to accessing, interacting with and/or viewing circuit information.

In some embodiments, a hierarchy order can include, in descending order of access/privileges: owner, administrator (Admin), automator, author, contributor and user.

In some embodiments, an owner owns a circuit, and can have privileges as a super-admin. An owner involves functionality for enabling other users as administrators, and can initiate the transfer of ownership to another user.

In some embodiments, administrators can be provided permissions by an owner, such as, for example, elevated privileges to assign authors, add new connectors, customize connectors, change settings, change subscriptions settings, and the like.

In some embodiments, an automator can create new data connectors 262 and/or circuit workflows 266, and request an admin make them live/active for ingestion.

In some embodiments, an author can add documents to a circuit and organize content (e.g., request and/or cause the operations of engine 200 to perform the ingestion of targeted sources, for example).

In some embodiments, a contributor can create circuit annotations, accept circuit annotations from other users, leave feedback, provide ratings, and the like; and

In some embodiments, a user is a consumer of a circuit (e.g., a subscriber, for example). In some embodiments, such a role can involve functionality to propose and/or comment on annotations for documents in a circuit.

In some embodiments, each user can have their own circuit (e.g., “My Circuit” 302, as in FIG. 3), for which they are an owner. Other circuits (e.g., circuits 308, 312 and 318, for example) can be owned by other users that have created them. Each circuit has its own user account (e.g., owner account) that has ownership, and corresponding privileges from the hierarchy associated therewith.

Accordingly, FIG. 3 depicts an example where circuit 302 is configured to ingest documents from circuits 308, 312 and 318. As depicted, for example, circuit 308 can include documents from source 306; circuit 312 includes documents from source 310; and circuit 318 includes documents from sources 314 and 316, and circuit 312. In some embodiments, the connectors enabling ingestion from such sources and circuits can include functionality for filtering content—for example, circuit 318 only may requests a portion of the documents in circuit 312; therefore, filter 304 can filter and identify such portion during extraction and ingestion into circuit 318.

Turning to FIG. 4, Process 400 provides non-limiting example embodiments for the disclosed systems and methods. As discussed in detail below, Process 400 provides non-limiting example embodiments for the generation of a circuit.

According to some embodiments, Steps 402 and 408 of Process 400 can be performed by identification module 202 of circuit engine 200; Steps 404 and 410 can be performed by analysis module 204; Steps 406 and 414 can be performed by determination module 206; and Steps 412 and 416 can be performed by output module 208.

According to some embodiments, Process 400 begins with Step 402 where engine 200 can receive a request from a user. According to some embodiments, the request can be in relation to the creation of a circuit. As discussed above, the user can be, but is not limited to, a person, company, organization, and the like. In some embodiments, the request can include information related to, but not limited to, a topic, event, user information, target sources, document types, and the like, or some combination thereof. For example, a request can provide information related to a user ID, user account, types and/or IDs of sources to target for documents, and the like.

In some embodiments, user information can include, but is not limited to, behaviors of the user, interests of the user, demographics, geography of the user, current activities, device types, and the like, or some combination thereof. In some embodiments, such user information can be retrieved upon receiving the request, where engine 200 can analyze the information identifying the user and retrieve such user information from a network location (e.g., database 108 for where user account and/or data can be stored therein).

In Step 404, engine 200 can perform a computational analysis of the request, which, in some embodiments, can include a comparative analysis of the requested data as it relates to the user information for purposes of compiling a circuit for the user. According to some embodiments, engine 200 can implement any type of known or to be known computational analysis technique, algorithm, mechanism or technology to perform such analysis.

In some embodiments, engine 200 may execute and/or include a specific trained artificial intelligence/machine learning model (AI/ML), a particular machine learning model architecture, a particular machine learning model type (e.g., convolutional neural network (CNN), recurrent neural network (RNN), autoencoder, support vector machine (SVM), and the like), or any other suitable definition of a machine learning model or any suitable combination thereof.

In some embodiments, engine 200 may leverage a large language model (LLM), whether known or to be known. A LLM is a type of AI system designed to understand and generate human-like text based on the input it receives. The LLM can implement technology that involves deep learning, training data and natural language processing (NLP). Large language models are built using deep learning techniques, specifically using a type of neural network called a transformer. These networks have many layers and millions or even billions of parameters. LLMs can be trained on vast amounts of text data from the internet, books, articles, and other sources to learn grammar, facts, and reasoning abilities. The training data helps them understand context and language patterns. LLMs can use NLP techniques to process and understand text. This includes tasks like tokenization, part-of-speech tagging, and named entity recognition.

LLMs can include functionality related to, but not limited to, text generation, language translation, text summarization, question answering, conversational AI, text classification, language understanding, content generation, and the like. Accordingly, LLMs can generate, comprehend, analyze and output human-like outputs (e.g., text, speech, audio, video, and the like) based on a given input, prompt or context. Accordingly, LLMs, which can be characterized as transformer-based LLMs, involve deep learning architectures that utilizes self-attention mechanisms and massive-scale pre-training on input data to achieve NLP understanding and generation. Such current and to-be-developed models can aid AI systems in handling human language and human interactions therefrom.

In some embodiments, engine 200 may be configured to utilize one or more AI/ML techniques chosen from, but not limited to, computer vision, feature vector analysis, decision trees, boosting, support-vector machines, neural networks, nearest neighbor algorithms, Naive Bayes, bagging, random forests, logistic regression, and the like. By way of a non-limiting example, engine 200 can implement an XGBoost algorithm for regression and/or classification to analyze the request and/or user information, as discussed herein.

In some embodiments and, optionally, in combination of any embodiment described above or below, a neural network technique may be one of, without limitation, feedforward neural network, radial basis function network, recurrent neural network, convolutional network (e.g., U-net) or other suitable network. In some embodiments and, optionally, in combination of any embodiment described above or below, an implementation of Neural Network may be executed as follows:
a. define Neural Network architecture/model,
b. transfer the input data to the neural network model,
c. train the model incrementally,
d. determine the accuracy for a specific number of timesteps,
e. apply the trained model to process the newly-received input data,
f. optionally and in parallel, continue to train the trained model with a predetermined periodicity.

In some embodiments and, optionally, in combination of any embodiment described above or below, the trained neural network model may specify a neural network by at least a neural network topology, a series of activation functions, and connection weights. For example, the topology of a neural network may include a configuration of nodes of the neural network and connections between such nodes. In some embodiments and, optionally, in combination of any embodiment described above or below, the trained neural network model may also be specified to include other parameters, including but not limited to, bias values/functions and/or aggregation functions. For example, an activation function of a node may be a step function, sine function, continuous or piecewise linear function, sigmoid function, hyperbolic tangent function, or other type of mathematical function that represents a threshold at which the node is activated. In some embodiments and, optionally, in combination of any embodiment described above or below, the aggregation function may be a mathematical function that combines (e.g., sum, product, and the like) input signals to the node. In some embodiments and, optionally, in combination of any embodiment described above or below, an output of the aggregation function may be used as input to the activation function. In some embodiments and, optionally, in combination of any embodiment described above or below, the bias may be a constant value or function that may be used by the aggregation function and/or the activation function to make the node more or less likely to be activated.

In Step 406, based on the analysis from Step 404, engine 200 can determine a context for the request, which can related to and/or be based upon the topic(s), target sources and/or user information included within and/or related to the request from Step 402. According to some embodiments, the determined context can be based on the computational AI/ML and LLM analysis performed via engine 200, as discussed above.

In some embodiments, such context can be stored in association with a user account (e.g., owner account, for example) in database 108, as discussed above.

In Step 408, engine 200 can compile a search for documents, connectors, other circuits and circuit workflows (e.g., types, formats, contexts, templates, and the like, or some combination thereof) based on the determined context. The search can include a query or set of queries that are defined by information representing the context, as well as information directing engine 200 to target the sources identified in the request as they relate to the topic. Thus, for example, a specific query can be created for each specific target source, which can have a specific type of connector associated therewith to perform the document search and extraction, as discussed supra.

For example, as depicted in FIG. 3, engine 200 can generate a request to establish network connectors to target sources: websites 306, 310 and 314 and/or circuits 308, 312 and/or 318.

According to some embodiments, with reference to FIG. 2, Step 408 can involve the establishment of connectors 258 between the network location of the to-be-generated circuit 252 (e.g., URL 270, discussed supra) and the location of the target source which can provide documents 260. According to some embodiments, connectors can be of certain types, as discussed above—for example, if a target source is a website, then the connector can be a website connector; if the target source is an email inbox, then the connector can be an email connector. As discussed above, such connectors can be configured to operate workflows to parse target sources and documents hosted therein, and extract requested data as identified from the request (in Step 402).

In some embodiments, connectors can ping and/or send requests to target sources to extract document artifacts, which can be according to a criteria (e.g., detection of document update), time period, user request, and the like. Indeed, such pinging can be according to a schedule, polling and/or re-ingest requests.

In some embodiments, the processing of extracted data can involve access mapping and/or source mapping (map documents to the source via artifact metadata applications) and/or normalization (e.g., extract data from the documents—for example, entities, hidden data, context, and the like).

In some embodiments, as discussed above respective to data connectors 262, connectors can be customized and/or of different types. For example, connectors can be, but are not limited to, standard connectors, advanced connectors, circuit workflows, API connectors, and the like, or some combination thereof.

In some embodiments, for example, a standard connector can be used for standard forms of content (e.g., email, online files, shared drives, and the like).

In some embodiments, for example, an advanced connector can be used for accessing mapping (e.g., making sure permissions are carried forward to the target source, which ensures the information ingested into the circuit is authorized).

In some embodiments, for example, a circuit workflow can correspond to a user-configurable data path to allow full configuration of ingest of certain events/data into a circuit, allowing a user to ingest from proprietary systems and/or apply any number of processing steps to the data before passing it into the circuit. In some embodiments, a circuit workflow can also process and update document metadata, permissions, user activity and other metadata as part of the ingest process.

In some embodiments, for example, a circuit workflow can also operate on data from a circuit and output it to another system, or be a connector between arbitrary systems, observable from the circuit.

And, in some embodiments, for example, an API connector can be used to retrieve data from remote systems—for example, ingest data via a representational state transfer (REST) API. For example, this can be triggered by an automator to make the connection with the remote system active.

Accordingly, each type of connector can be utilized to identify and retrieve (e.g., extract) documents from the target sources. Moreover, in some embodiments, each type of connector can have a sub-type, which can be used for specific types of document extraction. For example, a connector can be a PDF connector to perform extraction from a PDF document.

According to some embodiments, the type of connector that can be used, beyond standard, may be tied to a subscription plan. For example, if a user has a lowest subscription plan or the “free”/public options, then only the standard connections may be available for targeting data. In another example, if the full subscription plan is used, an advanced connector can be used, which can adapt and streamline how the user's interests may dynamically change over time, as well as map permissions from the target source into the circuit.

In Step 410, based on the search (and connector workflow execution discussed above in Step 408, inter alia), identified documents can be analyzed by engine 200. As discussed above, each document identified and retrieved has content and associated data/metadata, which can include, but is not limited to, creation date, creator ID, time, source, location (e.g., URL, for example), usage information (e.g., number of views, likes, and the like), and the like. In some embodiments, subject to the connectors' workflows retrieving the documents, the documents can be annotated (e.g., normalized, as discussed above) to include information related to which connector was used, hidden data, timing of retrieval, and the like.

According to some embodiments, the processing performed in Step 410 can involve the processing performing in Process 600, discussed infra.

According to some embodiments, in Step 412 engine 200 can compile the documents and perform an LLM based analysis. In some embodiments, Step 412 may not be required to be performed, and such performance can be based on user preference and/or automatically determined based on a type, quantity and/or sensitivity of documents retrieved. For example, if a document is retrieved and has a number of views below a threshold, then the LLM processing in Step 412 may be automatically initiated.

Accordingly, in some embodiments, Step 412 can involve analyzing, via an LLM(s), the retrieved documents, and generating a prompt for the requesting user to respond to. Such prompt can be, for example: “is this document (or documents) what you intended?” In another example, a prompt can recite “is there further information related to this document to retrieve?”

Thus, in response, in some embodiments, a user can provide input to the prompt, whereby the LLM can cause engine 200 to further execute a workflow based therefrom. For example, if the documents are identified, in response to the prompt, as not-relevant, then re-ingestion from the source can be performed and/or another source can be requested to be provided via another LLM prompt interaction with the user.

In Step 414, which can operate from Step 410 and/or Step 412, as discussed above, engine 200 can operate to compile the documents into the circuit. By way of reference to FIG. 2, engine 200's execution of Step 414 involves the ingestion of ingested documents 256 into the circuit 252, discussed supra. In some embodiments, the manner specific documents are processed/ingested into the circuit can be based on/resultant from the connector type and/or connector processing used to extract the documents from the source. For example, if a document is within another circuit, then reference (e.g., pointer, for example) that document within the other circuit can be generated and added to the circuit, as discussed above.

According to some embodiments, the documents (and corresponding extracted data/metadata, as discussed in relation to Process 600, infra) being ingested can be stored and/or referenced as part of the circuit data structure, as discussed above. In some embodiments, Step 414 can involve the creation of a circuit data structure that includes information related to such documents (e.g., the documents content (e.g., data/metadata) and/or pointers to network locations (e.g., sources and/or other circuits)). Such documents and data/metadata can be stored in database 108 (e.g., in relation to the owner's account).

In some embodiments, the ingestion of the documents (and corresponding data/metadata) can be based on a determined bias, which can be based on the context and/or user information. For example, the time of day, user's location and/or other patterns of behavior can cause the manner the documents are ingest and/or the way they are configured into the circuit to be modified.

In some embodiments, the compilation of the circuit can involve the configuration of the circuit, which can dictate how the documents are to be presented within a UI, which type of UI, a URL address (as discussed above respective to URL 270) and/or how such documents can be accessed. The documents, within the interactive circuit UI, can be capable of being opened, saved, retrieved, shared, modified, and the like. Accordingly, within the displayed UI, a set of interface objects (IOs) can be provided which can enable such interactions/action, which, as discussed below, may be recommended based on information from the circuit, documents and/or user, and the like.

And, in Step 416, engine 200 can operate to output the compiled circuit to a network location. According to some embodiments, as discussed above, the circuit can have an assigned URL, as discussed above, which can be in relation to the web site for where the circuit is located. For example, a circuit for Company X, as discussed above, can be found at: https://circuit.ai/C/CompanyX/. Another example of a URL is provided in FIG. 2 respective to URL 270.

According to some embodiments, Step 416 can involve engine 200 performing, via an AI/ML model(s) and/or LLM(s)-based analysis of the circuit, documents ingested therein and/or user information (as discussed above in relation to at least Step 402), a determination of recommended actions for the user. For example, engine 200 can determine that another user (e.g., the user's co-worker) would be interested in the circuit the user created related to the project they are working together. In another example, the user's spouse may be interested in the user's circuit they created in relation to summer activities for the children.

Accordingly, in some embodiments, Step 416 can involve the compilation and generation of a set of instructions that can additionally be displayed and provided to the user via the displayed circuit UI (and/or other forms of messaging providing options for the user to act). Such instructions, for example, can include, but are not limited to, sending a message to another user, annotating the circuit (e.g., as per annotations 254, discussed supra), posting to a social forum, adjusting permissions/settings for other users to view the circuit, requesting additional documents to be retrieved (e.g., effectively performing a re-ingest operation and/or establishing another connector with a target source (and performing the steps of Process 500, discussed infra)), and the like, or some combination thereof. Thus, such recommended actions can effectuate and/or cause controls to be provided in association with the displayed and/or rendered circuit so that controls as to how the circuit is managed on a network are provided.

In some embodiments, Step 416 can facilitate, enable and/or cause interaction with the circuit, documents included therein and/or the data/metadata included therein (e.g., as discussed in Process 600, discussed infra). In some embodiments, the operations of Step 416 can provide executed instructions that output a query and/or capabilities for a user to interact with the circuit, and/or a portion of the documents and/or data/metadata therein.

For example, in some embodiments, Step 416 can involve engine 200 leveraging an LLM engine to prompt a user to request what information from their circuit they are currently interested in. In response, engine 200 can retrieve such information; and in some embodiments, should such information not be currently available within the circuit, engine 200 can perform the steps of Process 400 to retrieve such information (and/or perform the steps of Process 500, as discussed infra).

In some embodiments, for example, the enabled interaction (e.g., providing information from within the circuit to the user) can be based on an input, a request, analysis (e.g., AI/ML and/or LLM analysis) of the information within the circuit and/or a criteria (e.g., time, user context, circuit context, date, location, an event, and the like, or some combination thereof), and the like, or some combination thereof.

Accordingly, in some embodiments, such interactions can be performed via the owner user of the circuit and/or a follower/subscriber user of the circuit, as discussed above.

In some embodiments, as discussed above, the circuit can also be provided as a network location/electronic resource made available from a proprietary circuit application, which can also have its own dedicated network location (e.g., a UI accessible from a circuit application, for example). Accordingly, a circuit is configured as a network hosted electronic resource that the requesting user (e.g., owner) can access, as well as other authorized users, depending on the read/write access configured to the circuit and its location, as discussed above.

Turning to FIG. 5, provided is Process 500 which details non-limiting embodiments for functionality related to modifying and/or updating, and providing overall management, of a created circuit.

According to some embodiments, Steps 502 and 504 of Process 500 can be performed by identification module 202 of circuit engine 200; Step 506 can be performed by analysis module 204; Step 508 can be performed by determination module 206; and Steps 510 and 512 can be performed by output module 208.

According to some embodiments, Process 500 begins with Step 502 where engine 200 can monitor activity over a network related to a circuit. Such monitoring can be according to a criteria, which can be based on, but not limited to, requests from a user, updates to documents and/or topics covered in the circuit, time periods (e.g., daily), context of the user (e.g., the user has arrived at work, arrived at home, went on vacation, is performing research, and the like), and the like. In some embodiments, such monitoring can occur periodically (e.g., according to a time period, for example) and/or continuously.

According to some embodiments, such monitoring can be performed via engine 200 executing the connector workflows for the circuit such that the connectors can ping, monitor, scrape, mine or otherwise check for supplemental and/or alternative data to ingested documents according to the criteria.

For example, engine 200 can determine whether there were updates to information collected as part of a circuit's compilation. For example, if a breaking news story was ingested, engine 200 can monitor target sources for whether updates to the breaking news story have been detected. In some embodiments, such update detection/determination can be performed via an AI/ML and/or LLM-based analysis on the information identified from a target source, which can be performed in a similar manner as discussed above.

Accordingly, in Step 504, based on the monitoring, engine 200 can detect an event. The event can correspond to the satisfaction of the criteria for which the monitoring is occurring. For example, the breaking news story has further developments to the story, as indicated via additional articles from a target source.

Accordingly, the event can have associated information, which can include, but not be limited to, content, source, connector ID and/or type, time, date, location, topic/category of content, associated circuit (e.g., ID of circuit for which the document(s) is being modified via the event, for example), user ID, and the like, or some combination thereof.

In Step 506, engine 200 can analyze the event information. In some embodiments, such analysis can be performed via the AI/ML and/or LLM operations, as discussed at least in relation to Step 404 of Process 400, discussed supra.

In Step 508, based on the analysis of the event information, engine 200 can determine attributes of the event. Such attributes can correspond to the content of the event, and/or provide features and/or characteristics of such content. In some embodiments, the attributes can further indicate similar information related to the event information, as discussed above (e.g., connector information, for example).

For example, for a story about a topic X and Y, the attributes can indicate that a connector retrieved additional documents that provide Z for the story, thereby modifying the story via an additional document that is to be ingested that causes the story to be “X, Y, Z.”

In Step 510, based on the determined attributes, engine 200 can update the circuit. In some embodiments, such updates, as discussed above, can involve the additional ingesting of documents. In some embodiments, such updates can be provided via annotations, which can be inline and/or whole-document, as discussed above. In some embodiments, the updates to the documents and/or circuit can cause the manner in which the documents of a circuit are displayed to be modified. For example, recently updated or more temporally related information may be moved to be displayed in a portion of the UI of the circuit that enables easier viewing (e.g., at the top of the UI page, for example).

According to some embodiments, the processing performed in Step 510 can involve the processing performing in Process 600, discussed infra.

And, in Step 512, engine 200 can cause promulgation of the updated circuit to connected (e.g., subscribed) users. Such promulgation can involve, but is not limited to, messages (e.g., emails, SMS messages, social media messages, circuit notifications, and the like), application notification, browser reloads, and the like. Such promulgations may cause, for example, haptic, audible and/or visual notifications, whether known or to be known, to be displayed on devices of connected users. In some embodiments, such promulgations can be effectuated via IOs and/or recommended actions, as discussed above at least in relation to Step 416 of Process 400 of FIG. 4.

And, in some embodiments, such promulgation in Step 512 can enable the interactions with a user (e.g., owner and/or follower/subscriber) of the circuit, as discussed above at least in relation to Step 416 of Process 400.

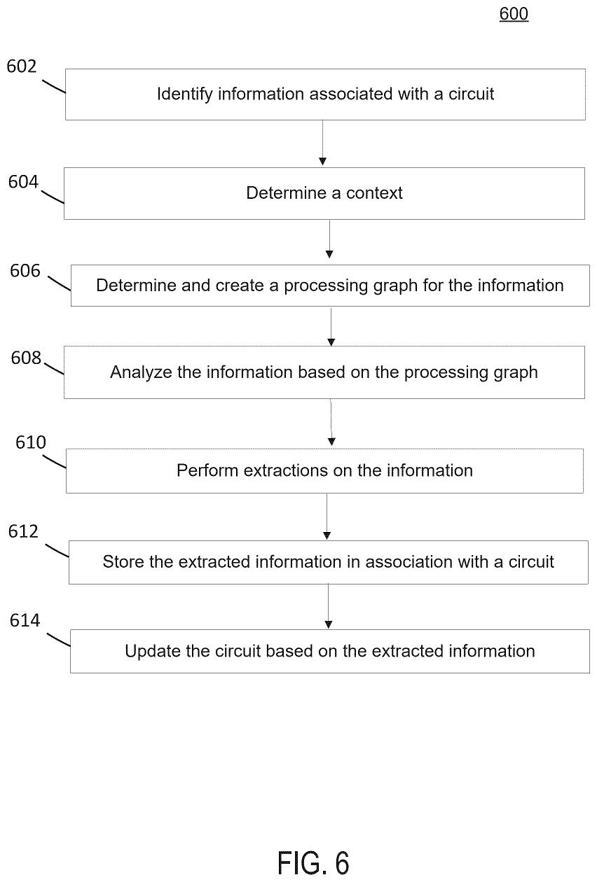

Turning to FIG. 6, Process 600 provides non-limiting embodiments for the dynamically performed computational analysis and ingestion of documents and/or associated information thereto for which data, metadata and/or other forms of content can be identified, extracted, determined, and stored for purposes of compiling, updating, publishing and/or promulgating a circuit and/or its included documents. In some embodiments, as discussed herein, such operations can enable curated and/or automated interactions with circuits and/or included documents/information by particular users.

According to some embodiments, Step 602 of Process 600 can be performed by identification module 202 of circuit module 202; Steps 604, 606 and 610 can be performed by determination module 206; Step 608 can be performed by analysis module 204; and Steps 612 and 614 can be performed by output module 208.

According to some embodiments, Process 600 can begin with engine 200 identifying information associated with a circuit. In some embodiments, such information can be related to, but not limited to, a document, other circuit, connector, circuit workflow, data connector, data/metadata for a document or target source, annotations, user information, a circuit as a whole, and the like, or some combination thereof. In some embodiments, the information can be information already ingested into the circuit already, information being processed for ingestion, information provided by a user, information being retrieved, and the like, or some combination thereof.

It should be understood that while the discussion herein may refer to a document, it should not be construed as limiting, as one of skill in the art would understand that any type of electronic content item, object or file and any quantity of such content can be subject to the processing discussed in relation to the steps of Process 600 without departing from the scope of the instant disclosure.

In some embodiments, such information, upon identification in Step 602, can be stored in database 108, as discussed above.

In Step 604, engine 200 can determine a context. In some embodiments, such context can correspond to, but is not limited to, a user context, circuit context, information context (e.g., context of annotation of a document, for example), and the like, or some combination thereof. In some embodiments, a context can additionally include information related to a criteria for when to perform the subsequent processing, which can correspond to, but not related to, a time, date, user location, user request, activity of a user (e.g., what is the user performing on a network and/or is the user active on a network, for example), and the like.

In Step 606, engine 200 can determine and create a processing graph for the identified information (from Step 602) based on the context (from Step 604). As discussed herein, the processing graph can define a set of executable instructions that can enable data/metadata or other forms of content extraction from the information (e.g., a document, for example). In some embodiments, the processing graph can be an executable file and/or data structure that can be caused to function, as discussed herein.

In some embodiments, such compilation of the processing graph can be performed via execution of any of the known or to be known AI/ML and/or LLM techniques discussed above, with the information and context used as inputs.

In some embodiments, the processing in Step 606 can involve specific operations to compile operations that are to be performed on the information. For example, tokenization (of the words and/or items within the information) and/or normalization, as discussed above.

Accordingly, the processing graph can derive an intent (from the context) for how the information is to be analyzed and which data/metadata is to be extracted and stored therefrom, as discussed herein. Indeed, as discussed herein, the processing graph determination can involve a determination as to what operations (and/or order) are required based on the context of the user, documents/information and/or circuit. In some embodiments, the mechanisms that can be executed can be tied to access rights associated with a user's subscription to a circuit, as tied to a role of the user, as discussed above. Accordingly, a master processing graph can be generated, which can involve a sequence of operations to be performed on the information, which can be performed based on a subscription level of a user (e.g., for an owner user, all the steps are performed, whereby for a user role, only a portion of the steps may be performed).

In Step 608, engine 200 can perform a computational analysis of the identified information (from Step 602) via execution of the determined processing graph (from Step 606). In some embodiments, the analysis performed via the processing graph can be performed via any of the known or to be known AI/ML and/or LLM techniques discussed above.

In Step 610, engine 200 can perform extractions on the information based on the execution of the processing graph, as in Step 608. According to some embodiments, upon execution of the processing graph, the processed information (e.g., document information and/or corresponding annotations, for example) can be stored (as discussed infra), which can be in association with the circuit in database 108. Such information can be utilized for subsequent processing, which can be tied to document retrievals, updates to a circuit/documents, promulgations to users, and the like.

According to some embodiments, by way of example, engine 200 can perform extractions based on an intent of the circuit (as defined by the determined context)—e.g. if the intent of the circuit is knowledge sharing for nurses, specific focus can be on extracting information related to nurses and nursing, as well as building a knowledge graph across related documents building up around these topics. In some embodiments, an intent of a circuit can be specified by the circuit author, can also be changed at any time, determined dynamically based on the documents included therein (by engine 200), and the like.

In some embodiments, by way of another example, information can be extracted related to users that may be determined to be impacted by such extracted information, whereby such impact can be quantified via engine 200 determining who can take action on the information, which actions can be taken, where and/or when can such actions be taken, and the like. For example, if the information relates to a new traffic pattern on a street, residents on the street would be identified as being impacted and subject to promulgations of such information.

Accordingly, engine 200's execution of the processing graph can involve the extraction of analytical information from a document, including processing text, images, video, multimedia, tables, figures, and the like, which can be utilized to then extract and/or determine quantities, meanings and/or implications, whereby both descriptive and quantitative annotations can be created and applied/appended to documents thereby providing meaning as well as specifics to be brought up to and queried by the user. In some embodiments, such contextual meaning determinations can be provided via an AI/ML and/or LLM (e.g., NLP) processing techniques, as discussed supra.

In Step 612, the processed information (e.g., extracted, determined, derived or otherwise identified data/metadata) from the information (from Step 602) can be stored, where the stored information can be, but is not limited to, embeddings, bitmaps, summaries (e.g., a summary of a document), a document object model (DOM), templates, headers, URLs, and the like.

And, in Step 614, engine 200 can update the circuit based on the extracted (and stored) information. Such updating can involve making the extracted information available via the circuit, promulgating a notification to a user (e.g., owner of the circuit and/or follower of the circuit), generating new actions to perform on the circuit, and the like. Accordingly, such updates in Step 614 can involve the operations of Step 416 of Process 400 and/or Step 512 of Process 500, discussed supra.

Accordingly, as discussed above at least in relation to FIGS. 2-6, the disclosed framework operates to build, curate and manage a circuit on/over a network at a network location via the retrieval and AI/ML and/or LLM-based analysis of data, which can enable enhanced consumption, and improved interactions on/over the network, with other network resources and/or other users.

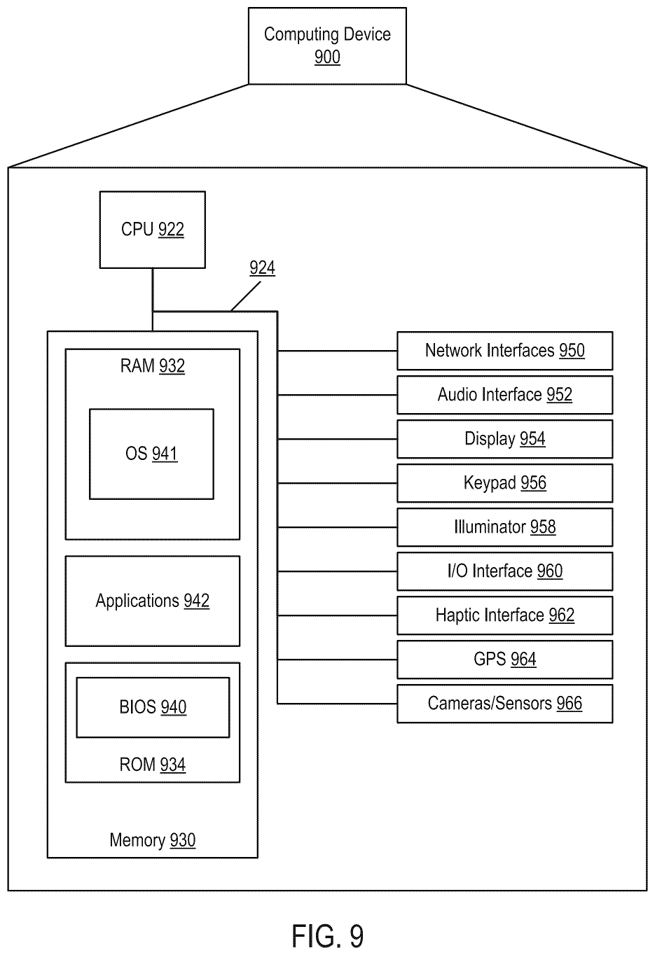

FIG. 8 is a schematic diagram illustrating a client device showing an example embodiment of a client device that may be used within the present disclosure. Client device 900 may include many more or less components than those shown in FIG. 9. However, the components shown are sufficient to disclose an illustrative embodiment for implementing the present disclosure. Client device 900 may represent, for example, UE 102 discussed above at least in relation to FIG. 1A.

As shown in the figure, in some embodiments, Client device 900 includes a processing unit (CPU) 922 in communication with a mass memory 930 via a bus 924. Client device 900 also includes a power supply 926, one or more network interfaces 950, an audio interface 952, a display 954, a keypad 956, an illuminator 958, an input/output interface 960, a haptic interface 962, an optional global positioning systems (GPS) receiver 964 and a camera(s) or other optical, thermal or electromagnetic sensors 966. Device 900 can include one camera/sensor 966, or a plurality of cameras/sensors 966, as understood by those of skill in the art. Power supply 926 provides power to Client device 900.

Client device 900 may optionally communicate with a base station (not shown), or directly with another computing device. In some embodiments, network interface 950 is sometimes known as a transceiver, transceiving device, or network interface card (NIC).

Audio interface 952 is arranged to produce and receive audio signals such as the sound of a human voice in some embodiments. Display 954 may be a liquid crystal display (LCD), gas plasma, light emitting diode (LED), or any other type of display used with a computing device. Display 954 may also include a touch sensitive screen arranged to receive input from an object such as a stylus or a digit from a human hand.

Keypad 956 may include any input device arranged to receive input from a user. Illuminator 958 may provide a status indication and/or provide light.

Client device 900 also includes input/output interface 960 for communicating with external. Input/output interface 960 can utilize one or more communication technologies, such as USB, infrared, Bluetooth™, or the like in some embodiments. Haptic interface 962 is arranged to provide tactile feedback to a user of the client device.

Optional GPS transceiver 964 can determine the physical coordinates of Client device 900 on the surface of the Earth, which typically outputs a location as latitude and longitude values. GPS transceiver 964 can also employ other geo-positioning mechanisms, including, but not limited to, triangulation, assisted GPS (AGPS), E-OTD, CI, SAI, ETA, BSS or the like, to further determine the physical location of client device 900 on the surface of the Earth. In one embodiment, however, Client device 900 may through other components, provide other information that may be employed to determine a physical location of the device, including for example, a MAC address, Internet Protocol (IP) address, or the like.

Mass memory 930 includes a RAM 932, a ROM 934, and other storage means. Mass memory 930 illustrates another example of computer storage media for storage of information such as computer readable instructions, data structures, program modules or other data. Mass memory 930 stores a basic input/output system (“BIOS”) 940 for controlling low-level operation of Client device 900. The mass memory also stores an operating system 941 for controlling the operation of Client device 900.

Memory 930 further includes one or more data stores, which can be utilized by Client device 900 to store, among other things, applications 942 and/or other information or data. For example, data stores may be employed to store information that describes various capabilities of Client device 900. The information may then be provided to another device based on any of a variety of events, including being sent as part of a header (e.g., index file of the HLS stream) during a communication, sent upon request, or the like. At least a portion of the capability information may also be stored on a disk drive or other storage medium (not shown) within Client device 900.

Applications 942 may include computer executable instructions which, when executed by Client device 900, transmit, receive, and/or otherwise process audio, video, images, and enable telecommunication with a server and/or another user of another client device. Applications 942 may further include a client that is configured to send, to receive, and/or to otherwise process gaming, goods/services and/or other forms of data, messages and content hosted and provided by the platform associated with engine 200 and its affiliates.

As used herein, the terms “computer engine” and “engine” identify at least one software component and/or a combination of at least one software component and at least one hardware component which are designed/programmed/configured to manage/control other software and/or hardware components (such as the libraries, software development kits (SDKs), objects, and the like).

Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. In some embodiments, the one or more processors may be implemented as a Complex Instruction Set Computer (CISC) or Reduced Instruction Set Computer (RISC) processors; x86 instruction set compatible processors, multi-core, or any other microprocessor or central processing unit (CPU). In various implementations, the one or more processors may be dual-core processor(s), dual-core mobile processor(s), and so forth.

Computer-related systems, computer systems, and systems, as used herein, include any combination of hardware and software. Examples of software may include software components, programs, applications, operating system software, middleware, firmware, software modules, routines, subroutines, functions, methods, procedures, software interfaces, application program interfaces (API), instruction sets, computer code, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium for execution by a processor. Modules may be integral to one or more servers, or be loaded and executed by one or more servers. One or more modules may be grouped into an engine or an application.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores,” may be stored on a tangible, machine readable medium and supplied to various customers or manufacturing facilities to load into the fabrication machines that make the logic or processor. Of note, various embodiments described herein may, of course, be implemented using any appropriate hardware and/or computing software languages (e.g., C++, Objective-C, Swift, Java, JavaScript, Python, Perl, QT, and the like).

For example, exemplary software specifically programmed in accordance with one or more principles of the present disclosure may be downloadable from a network, for example, a website, as a stand-alone product or as an add-in package for installation in an existing software application. For example, exemplary software specifically programmed in accordance with one or more principles of the present disclosure may also be available as a client-server software application, or as a web-enabled software application. For example, exemplary software specifically programmed in accordance with one or more principles of the present disclosure may also be embodied as a software package installed on a hardware device.

For the purposes of this disclosure the term “user”, “subscriber” “consumer” or “customer” should be understood to refer to a user of an application or applications as described herein and/or a consumer of data supplied by a data provider. By way of example, and not limitation, the term “user” or “subscriber” can refer to a person who receives data provided by the data or service provider over the Internet in a browser session, or can refer to an automated software application which receives the data and stores or processes the data. Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than, or more than, all of the features described herein are possible.

Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

What is claimed is:

1. A method comprising:
identifying, over a network, information related to a set of target sources over the network, each target source being a network location that hosts electronic documents;
searching, over the network, based at least on user information related to a user, each of the target sources, the user information comprising information that corresponds to a context;
determining, based on the search of each target source, a set of electronic documents, the set of electronic documents comprising content that is related to the context;
ingesting, over the network, the set of electronic documents into a circuit, the circuit being an electronic data structure for which the user is an owner; and
outputting, over the network, the circuit to an electronic resource, the electronic resource being an interactive network location for which the user and other users are capable of interacting with the set of electronic documents.

2. The method of claim 1, further comprising:
analyzing the set of electronic documents based at least in part on the user information;
determining a set of recommended actions to be performed in relation to the circuit; and
outputting, in connection with the electronic resource, the set of recommended actions, such that control of or interaction with the circuit over the network is enabled via output of the set of recommended actions, the set of recommended actions being at least one of temporally, spatially, socially, emotionally and logically relevant to the user.

3. The method of claim 1, further comprising:
analyzing data of each of the set of electronic documents, the analysis comprising normalizing the data of each electronic document in the set of electronic documents; and
determining a configuration of the set of electronic documents within a rendering of the circuit, wherein the set of electronic documents are displayed according to the configuration upon the outputting of the circuit to the electronic resource.

4. The method of claim 1, further comprising:
determining, based on the information related to the set of target sources, a type of connector for each target source, a connector being an executable workflow for identifying and extracting content from a target source; and
performing the ingestion of the set of electronic documents from the set of target resources via each type of respective connector.

5. The method of claim 4, wherein the types of connectors are at least one of a standard connector, advanced connector, circuit workflow and Application Program Interface (API) connector, wherein each connector type comprises specific capabilities for extracting types of content from a target source.

6. The method of claim 4, wherein the types of connectors are based on a type of information retrieved from a target source.

7. The method of claim 1, further comprising:
detecting, based on detection of an occurrence of a criteria, an event that corresponds to an update of content included in the circuit;
ingesting, over the network, the updated content from a target source that is hosting the updated content; and
updating the circuit based on the ingesting of the updated content.

8. The method of claim 7, further comprising:
promulgating, over the network, the updated circuit via the electronic resource.

9. The method of claim 1, further comprising:
analyzing the set of electronic documents based on the context;
determining a processing graph, the processing graph defining a set of executable operations for extracting information from the set of electronic documents;
analyzing the set of electronic documents based on the processing graph;
extracting, based on the processing graph analysis, the information from the set of electronic documents; and
storing the extracted information in relation to the circuit, the storage enabling promulgation of the extracted information to at least one user over the network.

10. The method of claim 1, wherein ingestion of an electronic document from the other circuit comprises including a reference to a network location associated with the other circuit for the electronic document within the data structure.

11. The method of claim 1, further comprising:
analyzing the user information and the information for the set of target sources; and
determining, based on the analysis, the context.

12. The method of claim 1, further comprising:
receiving, from the user, a request for generation of the circuit, the request comprising the user information and an indication of a circuit context; and
identifying the set of target sources based on the circuit context.

13. The method of claim 12, wherein the user information comprises an indication of at least one of an identifier (ID) of the user, interests of the user, behaviors of the user, demographics of the user and geography of the user.

14. The method of claim 1, wherein the user is at least one of a person, a group of people, entity, company, organization, government, agency and municipality.

15. A system comprising:
a processor configured to:
identify, over a network, information related to a set of target sources over the network, each target source being a network location that hosts electronic documents;
search, over the network, based at least on user information related to a user, each of the target sources, the user information comprising information that corresponds to a context;
determine, based on the search of each target source, a set of electronic documents, the set of electronic documents comprising content that is related to the context;
ingest, over the network, the set of electronic documents into a circuit, the circuit being an electronic data structure for which the user is an owner; and
output, over the network, the circuit to an electronic resource, the electronic resource being an interactive network location for which the user and other users are capable of interacting with the set of electronic documents.

16. The system of claim 15, wherein the processor is further configured to:
analyze the set of electronic documents based at least in part on the user information;
determine a set of recommended actions to be performed in relation to the circuit; and
output, in connection with the electronic resource, the set of recommended actions, such that control of or interaction with the circuit over the network is enabled via output of the set of recommended actions, the set of recommended actions being at least one of temporally, spatially, socially, emotionally and logically relevant to the user.

17. The system of claim 15, wherein the processor is further configured to:
determine, based on the information related to the set of target sources, a type of connector for each target source, a connector being an executable workflow for identifying and extracting content from a target source; and
perform the ingestion of the set of electronic documents from the set of target resources via each type of respective connector.

18. The system of claim 15, wherein the processor is further configured to:
detect, based on detection of an occurrence of a criteria, an event that corresponds to an update of content included in the circuit;
ingest, over the network, the updated content from a target source that is hosting the updated content;
update the circuit based on the ingesting of the updated content; and
promulgate, over the network, the updated circuit via the electronic resource.

19. The system of claim 15, wherein the processor is further configured to:
analyze the set of electronic documents based on the context;
determine a processing graph, the processing graph defining a set of executable operations for extracting information from the set of electronic documents;
analyze the set of electronic documents based on the processing graph;
extract, based on the processing graph analysis, the information from the set of electronic documents; and
store the extracted information in relation to the circuit, the storage enabling promulgation of the extracted information to at least one user over the network.

20. A non-transitory computer-readable storage medium tangibly encoded with computer-executable instructions that when executed by a processor, perform a method comprising:
identifying, over a network, information related to a set of target sources over the network, each target source being a network location that hosts electronic documents;
searching, over the network, based at least on user information related to a user, each of the target sources, the user information comprising information that corresponds to a context;
determining, based on the search of each target source, a set of electronic documents, the set of electronic documents comprising content that is related to the context;
ingesting, over the network, the set of electronic documents into a circuit, the circuit being an electronic data structure for which the user is an owner; and
outputting, over the network, the circuit to an electronic resource, the electronic resource being an interactive network location for which the user and other users are capable of interacting with the set of electronic documents.
